(19) United States
(12) Patent Application Publication
(10) Pub. No.: US 2007/0088670 A1
(43) Pub. Date: Apr. 19, 2007

(54) Methods and apparatus for performing lawful interception of network-centric services data stored within an XDM framework

(75) Inventor: Antti Laurila, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/324,395

(22) Filed: Jan. 3, 2006

(30) Foreign Application Priority Data
Oct. 14, 2005 (FI) 20051039

(51) Int. Cl. G06F 17/30

(52) U.S. Cl. 707/1

(57) ABSTRACT

The invention relates to a group and list management system, namely an XML document management system, XDM. In the system, user-specific service-related information is contained in at least one of group and list XML documents stored in network repositories, called XML document management servers, XDMS (131, 132). In a method of the invention, intercept-related information concerning XML documents is sent to a law enforcement monitoring facility (220) via an aggregation proxy (115) for a lawful interception purpose.

Priority is herewith claimed under 35 U.S.C. § 119(a) from Finnish Patent Application 20051039, filed on Oct. 14, 2005 by Antti Laurila entitled “Lawful Interception”. The disclosure of this Finnish Patent Application is hereby incorporated by reference in its entirety as if fully restated herein.

### TECHNICAL FIELD

The invention generally relates to lawful interception. More particularly, but not exclusively, the invention relates to lawful interception in XML (Extensible Markup Language) document management.

### BACKGROUND:

The Open Mobile Alliance (OMA) has defined a generic framework for group and list management called XDM (XML document management). XDM defines a common mechanism that makes user-specific service-related information accessible to different service enablers that need them. Such information is stored in the network where it can be located, accessed and manipulated (e.g., created, modified, retrieved, deleted) by service enablers as well as by XDM clients (or users), such as mobile stations. Examples of service enablers that currently use or can use XDM are PoC (Push-to-Talk over Cellular), Presence, Instant Messaging (IM), and a variety of gaming services.

FIG. 1 shows a typical XDM framework. User-specific service-related information is maintained in group and list documents. These XML documents typically identify a list of members of the group in question. Or, they may contain specific rules generated for the group(s) or user(s) in question. For example, in a PoC service, PoC access policy documents and PoC group documents are used. Each PoC user has an access policy document, which is used for controlling incoming PoC session invites. PoC group documents are used to control PoC group sessions. Similarly, in a Presence service, authorization policy documents and presence lists documents (such as RLS presence list documents (Resource List Server)) are typically used. Authorization policy documents are used to authorize a watcher subscribing to a person's presence information, and presence list documents are used to further personalize the service.

The aforementioned XML documents are stored in logical repositories in the network, called XML document management servers (XDMS). Uniform resource identifiers (URI) or uniform resource locators (URL) are used to identify the documents. There are two types of XDMSs: enabler specific XDMS 131 and shared XDMS 132.

Enabler specific XDMSs 131 are enabler-specific, and their information is used by corresponding enabler servers 120. This means that a PoC server uses a PoC XDMS, a Presence Server uses a Presence XDMS and so on. If, for example, a PoC service is taken as an example, it is typical that a PoC server accesses a PoC XDMS to obtain a particular type of user document, a PoC group document, which provides the member list for a PoC group session. The PoC server uses this information to invite such members to a PoC session.

Shared XDMSs 132 are repositories to be used by a plurality of service enablers. When the same group or list document is of use in a plurality of services, it is sensible to store this document in a shared XDMS 132 wherefrom each service enabler can access it when needed.

An XDM client 105 is able to access and manipulate XML documents by using XCAP protocol (XML Configuration Access Protocol). In other words, these kinds of operations are performed using an XCAP layer which resides above the HTTP (Hypertext Transfer Protocol) layer in a protocol stack. The client 105 transmits an XCAP request to an XDMS 131, 132, which takes appropriate action and returns a response to client 105. Currently, XDM client 105 has a single contact point for XCAP requests, namely an aggregation proxy (AP) 115. Accordingly, transmitted XCAP requests first pass via an XDM-3 interface to aggregation proxy 115. Aggregation proxy 115 authenticates and routes the received XCAP requests to a correct XDMS 131, 132. Aggregation proxy 115 also forwards the response back to the XDM client 105.

XDM client 105 identifies elements inside one XML document stored in an XDMS and modifies those elements, when needed. In practice, XDM client 105 manipulates an XML document (i.e., an XDM resource) by invoking (from the XCAP layer) certain HTTP layer operations on the XDM resource in question. The XDM resource may be identified by a combination of an application unique ID (AUID) and an XCAP user ID (XUI). The AUID identifies the application (or service enabler) in question. In this way the correct XDMS also will be identified. The XUI, in turn, identifies the user in question.

In addition to the mentioned XDM-3 interface, the XDM framework has other defined interfaces: an XDM-1 interface between the XDM client 105 and network core 150, an XDM-2 interface between the shared XDMS 132 and the network core 150 and an XDM-4 interface between the aggregation proxy 115 and the shared XDMS 132. The network core 150 corresponds to the part of the IP (Internet Protocol) based or other network though which service-related signaling, such as SIP (Session Initiation Protocol) and/or GPRS signaling (GPRS), and payload is communicated. Dashed lines in FIG. 1 indicate enabler-specific reference points for communication.

Different XDMSs 131, 132 store at least the following information:

1) Group documents: a group document is a list of members of the group in question (PoC group, IM group, etc . . . );

2) User access policies: a user access policy defines access rules of the group in question (PoC Group, IM group, etc . . . );

3) Presence lists: a Presence list is used to subscribe, on behalf of a watcher, to the presence status of a list of presentities (presentities are users whose presence information the watcher is interested in);

4) Presence authorization rules (subscription authorization rules): these define who is authorized to subscribe to a presentity's presence information; and

5) The content of notifications sent to each watcher (presence rules): presence rules may, for example, define which information is sent to each watcher; depending on the watcher, different information can be sent.

One general requirement for lawful interception (LI) is that all telecommunications traffic and information needs to be open to interception. The term “lawful interception” means an action, authorized by law and performed by a network operator, access provider and/or service provider (hereinafter referred to as an operator), whereby certain information is made available and provided to a law enforcement monitoring facility (LEMF). The term “law enforcement monitoring facility” (“LEMF”), in turn, means a law enforcement facility designated as the transmission destination for the results of lawful interception activity relating to a particular interception subject. The term “interception subject” means a person or persons, specified in a lawful authorization, whose telecommunications are to be intercepted.

The block diagram depicted in FIG. 2 shows a conventional system for performing lawful interception. The prior-art system comprises devices and functions both within the domain of an operator and within the domain of law enforcement agencies (LEA). Here, “law enforcement agency” (LEA) means an organization acting pursuant to a lawful authorization based on a national law that requests telecommunications interception measures and receives the results of telecommunications interceptions performed in accordance with telecommunications interception measures.

As shown in FIG. 2, the law enforcement monitoring facility (LEMF) 220 communicates with the operator domain via the lawful interception handover interface, i.e., the HI interface. The handover interface is a physical and logical interface across which interception measures are requested from the operator domain, and the results of interception are delivered by the operator domain to LEMF 220.

LEMF 220 communicates with the operator's administration function 211 via handover interface port 1 (HI1). By communicating with the administration function 211, LEMF 220 can place persons under surveillance and remove persons from surveillance.

LEMF 220 communicates with an IRI (intercept related information) mediation function 212 via handover interface port 2 (HI2). From IRI mediation function 212, LEMF 220 receives information or data associated with telecommunication services, other than the actual payload. This information or data may involve a target identity, specifically communication-associated information or data (e.g. unsuccessful communications attempts), service-associated information or data and location information.

LEMF 220 communicates with a CC (content of communication) mediation function 213 via handover interface port 3 (HI3). From CC mediation function 213, LEMF 220 receives the actual content of communication (payload, user data). By definition, content of communication means information exchanged between two or more users of a telecommunications service (e.g., speech, data), excluding intercept related information. This includes information that may, as part of some telecommunications service, be stored by one user for subsequent retrieval by another.

The IRI mediation function 212 typically obtains the intercept-related information and the CC mediation function 213 obtains the content of communication to be sent to the LEMF 220 from the network's internal functions 205. The network's internal functions 205 may specifically provide an internal intercepting function (IIF), which is a point within a network or network element at which the content of communication (CC) and the intercept-related information (IRI) are made available. The IRI and CC are sent to mediation functions 212 and 213 via an internal network interface (INI) or similar apparatus.

As is apparent from the preceding description, XDMSs contain valuable information (group and list documents) of interest to law enforcement agencies (LEA). However, it has been observed that neither this information nor manipulations of this information can be either accessed or detected by LEAs using conventional lawful interception methods and apparatus.

Further, it has been observed that LEAs currently have to rely on SIP and IP core-level lawful interception, which does not capture information contained in XDMSs. Accordingly, LEAs do not have access to the above-mentioned valuable information. The above-mentioned information cannot be derived from other sources because it is not available in the normal content of communication (CC), which can be taken from the GPRS-level or similar. Neither can it be derived from interception related information (IRI), which is taken from SIP-signalling and/or GPRS-signalling or similar.

LEAs are able to access CC from/towards a monitored user (e.g., PoC call data) and IRI from/towards a target (GPRS and/or SIP signaling information) from network core. However, for examples concerning PoC service, it has been observed that LEAs in most cases lack complete information about a PoC group because LEAs typically do not have access to information concerning a PoC group. For example, LEAs cannot identify all participants in a PoC group unless all participants first send a speech burst.

As a result, LEAs are unable to access information identified in the preceding points 1-5 and information concerning actions of an interception subject (or other authorized person) whereby the information related to the interception subject is manipulated.

Accordingly, those skilled in the art seek methods and apparatus for accomplishing the lawful interception of information contained in XDMSs. In particular, those skilled in the art seek methods and apparatus for accessing both this information and manipulations of this information.

### SUMMARY OF THE PREFERRED EMBODIMENTS

The foregoing and other problems are overcome, and other advantages are realized, in accordance with the presently preferred embodiments of these teachings.

According to a first aspect of the invention there is provided a method in a group and list management system in which user-specific service-related information is contained in at least one of group and list documents stored in network repositories, wherein the method comprises: retrieving information concerning the at least one of group and list documents from the group and list management system; and sending the information concerning the at least one of group and list documents from the group and list management system to a law enforcement agency.

In accordance with embodiments of the invention it is possible to intercept, for example, group- and presence-related information stored in the network (in XML documents) as well as manipulation of this data.

Advantageously, the information is sent by a network element or function (such as an aggregation proxy of an XDM system) which performs security procedures (e.g., authentication of XDM clients) as well as request forwarding procedures (e.g., for HTTP traffic). For XDM clients implemented in user equipments, the aggregation proxy functions as a contact point for accessing XML documents stored in XDMSs. The aggregation proxy performs authentication of XDM clients and routes individual XCAP requests to correct XDMS based on AUID identifier. In an embodiment of the invention, the aggregation proxy provides an interface for sending intercept related information to authorities.

According to a second aspect of the invention there is provided a group and list management system adapted to store user-specific service-related information contained in at least one of group and list documents in network repositories, wherein the system comprises: a network element to perform at least the following operations, the operations comprising: retrieving information concerning the at least one of group and list documents from the group and list management system; and sending the information concerning the at least one of group and list documents to a law enforcement agency.

According to a third aspect of the invention there is provided a network element for a group and list management system in which system user-specific service-related information is contained in at least one of group and list documents stored in network repositories, wherein the network element comprises: means for retrieving information concerning the at least one of group and list documents from the group and list management system; and means for sending the information concerning the at least one of group and list documents to a law enforcement agency.

Advantageously, the network element is a server. It can be a list management server (LMS) located between clients of the system and the storage elements (or local repositories in a network, e.g., XDMSs) in which the group and list documents are stored.

According to a fourth aspect of the invention there is provided a physical memory medium storing a computer program, wherein the computer program is for use in a group and list management system in which system user-specific service-related information is contained in at least one of group and list documents stored in network repositories, wherein when the computer program is executed by a network element of the group and list management system operations are performed, the operations comprising: retrieving information concerning the at least one of group and list documents from the group and list management system; and sending the information concerning the at least one of group and list documents to a law enforcement agency.

In conclusion, the foregoing summary of aspects and embodiments of the present invention is exemplary and non-limiting. For example, one skilled in the art will understand that one or more aspects or steps from one embodiment can be combined with one or more aspects or steps from another embodiment of the present invention to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 shows functional entities in XML document management architecture;

FIG. 2 shows a traditional model for lawful interception; and

FIG. 3 shows an XML document management interception configuration in accordance with an embodiment of the invention.

### DETAILED DESCRIPTION OF THE PREFERRED EMBODIMENTS

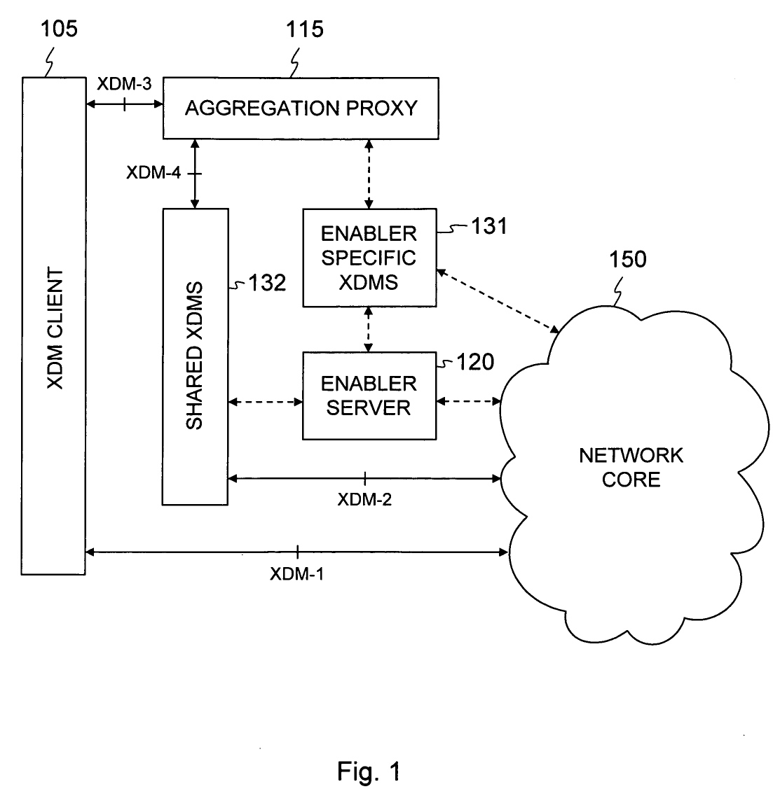

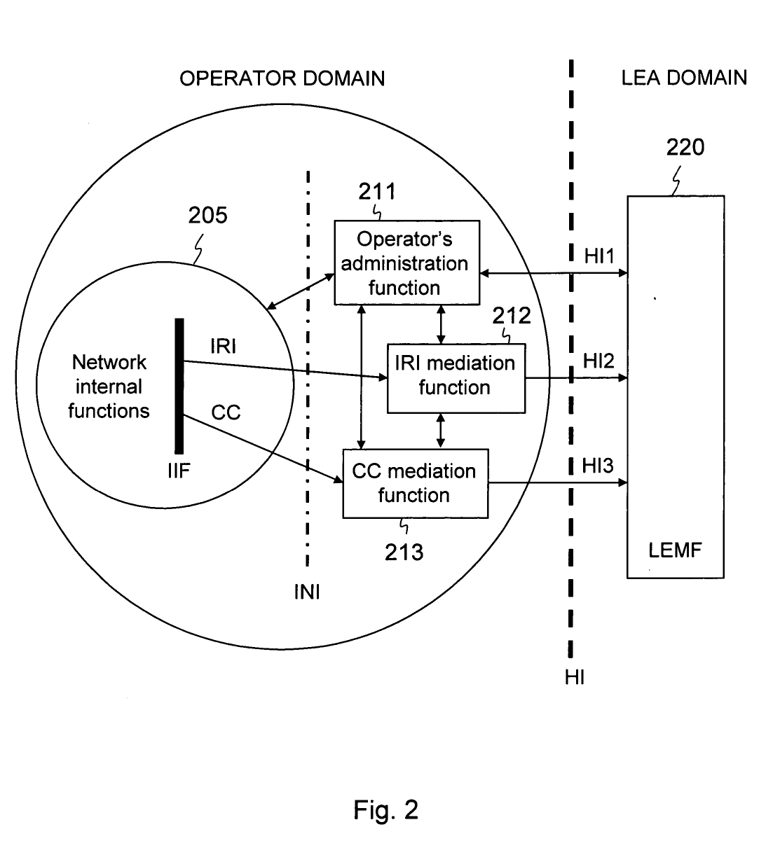

FIGS. 1 and 2 have been described in the preceding. That description is used to support the following description.

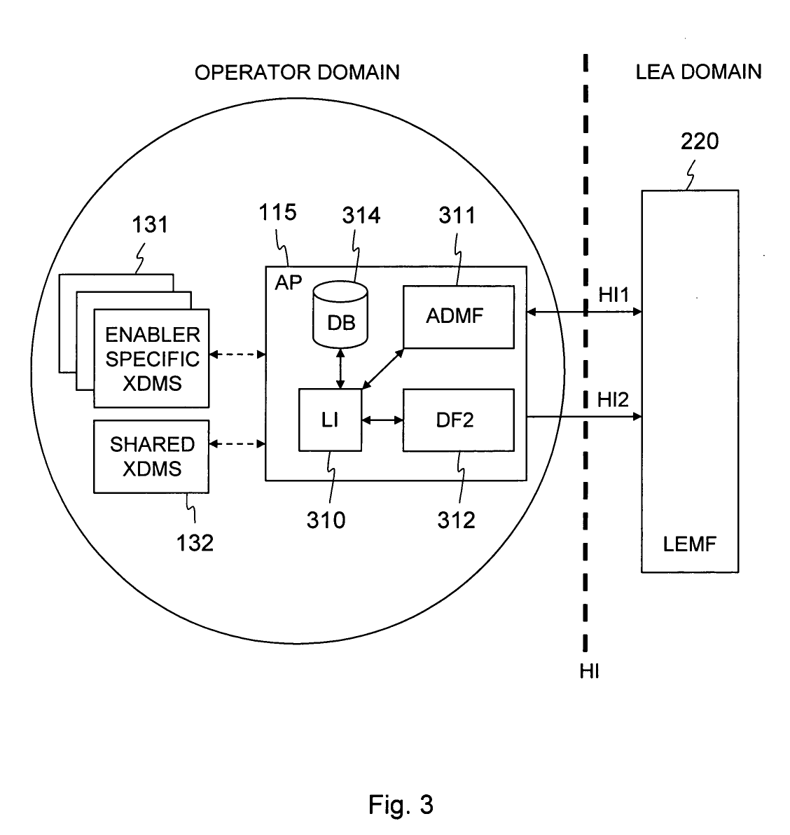

FIG. 3 shows an XML document management (XDM) interception configuration in accordance with an embodiment of the invention. It is to be understood that, in the following, XDM represents an example of a group and list management function. However, the invention is not restricted to XDM only, but is applicable to other current and future group and list management functions and systems, too.

In accordance with this embodiment, the aggregation proxy 115 is provided with a mechanism for lawful interception of XDM. The aggregation proxy 115 comprises a set of logical functions represented by blocks 310-312: an LI functions block 310 (lawful interception functions); an ADMF block 311 (administrative function); and a DF2 block 312 (delivery function 2 for intercept related function (IRI)). These functions co-operate to implement the HI1 and HI2 interfaces (or ports) towards LEMF 220.

The ADMF block 311 is adapted to communicate administrative information with LEMF 220 via HI1 interface. It is adapted to receive from LEMF 220 requests for setting interception subject(s) under surveillance as well as requests for removing them from surveillance, and to send to LEMF 220 responses to said requests. The ADMF block 311 forwards this kind of administrative information to LI functions block 310, which gathers IRI information concerning interception subjects and keeps track of interception subjects in an internal database 314 of the aggregation proxy 115.

The DF2 block 312 is adapted to communicate IRI information to LEMF 220 via HI2 interface. The DF2 block 312 receives the IRI from LI functions block 310, which gathers said information from the enabler specific XDMSs 131 or shared XDMS 132. Alternatively, or in addition, the LI functions block 310 gathers IRI from different messages passing the aggregation proxy 115.

In an embodiment, LEMF 220 is provided with information about the contents of the group and list documents of the interception subject in question. The aggregation proxy 115 generates an XCAP retrieve request (above HTTP protocol or similar) and sends it to XDMSs within its domain (operator domain) to get definitions of existing groups, user access policies, presence lists, presence rules and presence authorization rules of the intercepted subject in question and forwards these documents to LEA domain over HI2 interface. This can be done at the time of LI activation over the HI1 interface. Information of activated LI subjects is stored in the internal database 314 of the aggregation proxy 115.

Since the XDMSs 131, 132 perform appropriate authorization checks on the XCAP request originator, it may be appropriate for the aggregation proxy 115 to set an additional parameter (LI Flag=TRUE or similar) to these XCAP requests sent to XDMS 131, 132. Then responses received from XDMSs 131, 132 will also contain additional parameters preventing the aggregation proxy 115 from forwarding responses to the intercepted subject, instead the responses are forwarded only to LEMF 220.

In another embodiment, authorities (or LEMF 220) expressly request interception subject related information (indirectly) from XDMSs by sending a request over HI1 interface to the aggregation proxy 115. The aggregation proxy 115 forwards this request to XDMSs within its domain again with additional LI flag set TRUE included in the XCAP request for including that response to this request shall not be sent to the user (interception subject, or XDM client), but will be sent to LEMF 220 instead. As a response, the XDMSs 131, 132 return those documents to the aggregation proxy 115 in which the requested user (or interception subject) is found, and the aggregation proxy 115 forward those documents to LEMF 220. This process can be done during the time of LI activation, or afterwards, if needed. Requested information can be, for example, as follows:
Information concerning groups in which the interception subject participates as a member (name of the group, other members, etc.); and
Users who have ordered presence information of the interception subject (who are interested in it).

In another embodiment, LEMF 220 is provided with information about manipulation of the group and list documents (or other IRI) of the interception subject in question. In this embodiment, the aggregation proxy 115 checks, for all incoming and outcoming messages (XCAP requests and/or XCAP responses), the XUI (XCAP User Identifier). If the XUI has been set as lawful interception subject in the internal database (list) 314, the aggregation proxy 115 copies this XCAP request/response and sends a copy of it towards LEMF 220 over HI2 interface for a lawful interception purpose.

In the following is shown a more detailed example illustrating the embodiment in which LEMF 220 was provided with information about the actual contents of the group and list documents of the interception subject in question.

In this example, lawful interception is set for a user, who is, for the purpose of this example, named Joe Criminal. His SIP URI “sip:joe.criminalαexample.com” is set as lawful interception subject in the internal database 314 of the aggregation proxy 115.

For the retrieval of all lists of the intercepted subject from all different XDMSs within its domain, by using XCAP protocol, the aggregation proxy 115 generates an HTTP GET request based on all appropriate AUIDs and the XUI. As mentioned in the preceding, the AUID identifies the application (or service enabler) in question. The XUI, in turn, identifies the user whose documents are requested. In other words, the AUID and the XUI indicate the correct XDMS and user, respectively.

An additional LI flag is set to these requests for differentiate them from requests received from XDM clients 105 (and thus subsequent responses to these requests are sent only to LEMF 220 (via the aggregation proxy 115), not to the interception subject, as he/she should not be made aware of the lawful interception). The HTTP GET request sent, for example, to a Presence XDMS (RLS XDMS) 131 would appear as follows:

GET http://xcap.example.com/service/rls -

services/users/sip:joe.criminal@example.com/˜˜/rls-services
HTTP/1.1

LI Flag = LEA1
. . .
Content-Length: 0

After the RLS XDMS 131 has performed the appropriate authorization checks on the request originator and noticed that LEA is authorized to perform this operation, the RLS XD MS 131 sends an HTTP “200 OK” response including the requested document in the body of the response message. The RLS XDMS 131 will add the received LI flag also to the response to indicate that this is not a normal user originated request. The response would appear as follows:

HTTP/1.1 200 OK
Etag: “etuk8”
LI Flag = LEA1”
. . .
Content-Type: application/rls-services+xml
<?xml version=“1.0” encoding=“UTF-8”?>
<rls-services xmlns=“urn:ietf:params:xml:ns:rls-services”

xmlns:rl=“urn:ietf:params:xml:ns:resource-lists”
xmlns:xsi=“http://www.w3.org/2001/XLMSchema-instance”>
<service uri=“sip:mysociety@example.com”>
<resource-list>http://xcap.example.com/services/resource-
lists/users/sip:bob.criminal@example.com/˜˜

/resource-lists/list[@name=%22spew%22]</resource-list>

<packages>

<package>presence</package>

</packages>

</service>
<service uri=“sip:friends@example.com”>

<list name=“friends”>

<rl:entry uri=“sip:bob.criminal@example.com”/>
<rl:entry uri=“tel:1234;phone-context=+12345678910”/>

</list>
<packages>

<packages>presence</package>

</packages>

</service>

</rls-services>

The aggregation proxy 115 notices the LI flag and routes the response to LEMF 220 over HI2 interface.

Yet another embodiment concerns terminating the lawful interception. When the interception subject is removed from surveillance the database 314 is updated accordingly. Terminating interception can be initiated by the LEMF 220, or it can be regulated by a timer. In the latter case, the aggregation proxy 115 may set up a timer at the time of LI activation. When the timer expires, the interception subject is automatically removed from surveillance. The aggregation proxy 115 informs LEMF 220 of the termination of interception by sending an appropriate message via HI1 interface.

The aggregation proxy mentioned in the embodiments of the invention can be implemented by a suitable combination of hardware and software in a suitable server or network element, for example in a list management server (LMS). The mentioned software comprises program code for identifying information that is to be transmitted to LEA. Further, it comprises program code for controlling transmissions (such as IRI transmission) to LEA as well as for handling requests (such as requests to set a person as an interception subject) received from LEA.

It has been mentioned in the preceding that the XUI (which may be a SIP URI or TEL URI or similar) identifies the user whose documents are requested. Currently, for a user it is not possible to request documents other than his/her own documents. However, this should be possible in the future. Therefore, in yet another embodiment, an identifier other than the XUI is generated and sent in XCAP requests. The purpose of this identifier is to identify the requester. The aggregation proxy checks the value of this identifier, for all incoming requests. If the value of this identifier indicates an interception subject, the aggregation proxy copies the XCAP request in question and sends a copy of it towards LEA over HI2 interface. In this way it should be possible (also in future systems) to send copies of all requests generated by an interception subject to LEA.

Thus it is seen that the foregoing description has provided by way of exemplary and non-limiting examples a full and informative description of the best methods and apparatus presently contemplated by the inventors for performing lawful interception of network-centric services data stored within an XDM framework. One skilled in the art will appreciate that the various embodiments described herein can be practiced individually; in combination with one or more other embodiments described herein; or in combination with networks differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

What is claimed is:

1. A method in a group and list management system in which user-specific service-related information is contained in at least one of group and list documents stored in network repositories, wherein the method comprises:
retrieving information concerning the at least one of group and list documents from the group and list management system; and
sending the information concerning the at least one of group and list documents to a law enforcement agency.

2. The method of claim 1, wherein the information sent to the law enforcement agency comprises contents of the at least one of group and list documents.

3. The method of claim 1, wherein the information sent to the law enforcement agency comprises information about manipulation of contents of the at least one of group and list documents.

4. The method of claim 1, wherein the information relating to the at least one of group and list documents is sent by a network element, which provides a contact point for clients of the system.

5. The method of claim 4, wherein the network element sends to a network repository a request requesting information about contents of the at least one of group and list documents.

6. The method of claim 5, wherein the network repository is an XML document management server (XDMS).

7. The method of claim 4, wherein the network element forwards to a network repository a request requesting information about contents of the at least one of group and list documents.

8. The method of claim 1, wherein the at least one of group and list documents is an XML document.

9. The method of claim 4, wherein the network element comprises a list management server (LMS) implementing an aggregation proxy of an XML document management system (XDM).

10. The method of claim 4 further comprising:
receiving a request from a law enforcement agency to set a person in the system as an interception subject, and wherein the network element checks each incoming request to determine whether the request identifies the interception subject.

11. The method of claim 1, wherein the service to which the user-specific service-related information refers is selected from a set of services comprising: PoC (Push-to-talk over Cellular), Presence, Instant Messaging (IM), and a gaming service.

12. A group and list management system adapted to store user-specific service-related information in at least one of group and list documents in network repositories, wherein the system comprises:
a network element to perform at least the following operations, the operations comprising:
retrieving information concerning the at least one of group and list documents from the group and list management system; and
sending the information concerning the at least one of group and list documents to a law enforcement agency.

13. The system of claim 12, wherein the information sent to the law enforcement agency comprises contents of the at least one of group and list documents.

14. The system of claim 12, wherein the information sent to the law enforcement agency comprises information about manipulation of contents of the at least one of group and list documents.

15. The system of claim 12, wherein the network element provides a contact point for clients of the system.

16. The system of claim 15, wherein the network element is adapted to send to a network repository a request requesting information about contents of the at least one of group and list documents.

17. The system of claim 16, wherein the network repository is an XML document management server (XDMS).

18. The system of claim 15, wherein the network element is adapted to forward to a network repository a request requesting information about contents of the at least one of group and list documents.

19. The system of claim 12, wherein the at least one of group and list documents is an XML document.

20. The system of claim 12, wherein the network element comprises a list management server (LMS) implementing an aggregation proxy of an XML document management system (XDM).

21. The system of claim 12, wherein the system comprises a database for setting a person as an interception subject based on a request received from the law enforcement agency, and wherein the network element is adapted to check each incoming request to determine whether the request identifies the interception subject.

22. The system of claim 12, wherein the service to which the user-specific service-related information refers is selected from a set of services comprising: PoC (Push-to-Talk over Cellular), Presence, Instant Messaging (IM), and a gaming service.

23. A network element for a group and list management system in which system user-specific service-related information is contained in at least one of group and list documents stored in network repositories, wherein the network element comprises:
means for retrieving information concerning the at least one of group and list documents from the group and list management system; and
means for sending the information concerning the at least one of group and list documents to a law enforcement agency.

24. The network element of claim 23, wherein the information sent to the law enforcement agency comprises contents of the at least one of group and list documents.

25. The network element of claim 23, wherein the information sent to the law enforcement agency comprises information about manipulation of contents of the at least one of group and list documents.

26. The network element of claim 23, wherein the network element provides a contact point for clients of the system.

27. The network element of claim 26, wherein the network element is adapted to send to a network repository a request requesting information about contents of the at least one of group and list documents.

28. The network element of claim 23 further comprising means for implementing an interface for communicating administrative information with the law enforcement agency and for sending intercept related information (IRI) to the law enforcement agency.

29. The network element of claim 26, wherein the network element is adapted to forward to a network repository a request requesting information about contents of the at least one of group and list documents.

30. The network element claim 23, wherein the at least one of group and list documents is an XML document.

31. The network element of claim 23, wherein the network element comprises a list management server (LMS) implementing an aggregation proxy of an XML document management system (XDM).

32. The network element of claim 23 further comprising an internal database for setting a person as an interception subject based on a request received from the law enforcement agency, and wherein the network element is adapted to check each incoming request to determine whether the request identifies the interception subject.

33. A physical memory medium storing a computer program, wherein the computer program is for use in a group and list management system in which system user-specific service-related information is contained in at least one of group and list documents stored in network repositories, wherein when the computer program is executed by a network element of the group and list management system operations are performed, the operations comprising:
retrieving information concerning the at least one of group and list documents from the group and list management system; and
sending the information concerning the at least one of group and list documents to a law enforcement agency.

34. The physical memory medium of claim 33, wherein the operations further comprise:
sending to a network repository a request requesting information about contents of the at least one of group and list documents.

35. The physical memory medium of claim 33, wherein the operations further comprise:
setting a person in an internal database as an interception subject based on a request received from the law enforcement agency, and
checking each incoming request to determine whether the request identifies the interception subject.
